(19) United States
(12) Patent Application Publication
(10) Pub. No.: US 2015/0373080 A1
(43) Pub. Date: Dec. 24, 2015

(54) DEVICES AND METHODS FOR OPENING ONLINE DOCUMENTS

(71) Applicants: Qingdao Hisense Media Network Technology Co., Ltd, Qingdao (CN); Hisense USA Corp., Suwanee, GA (US); Hisense International Co., Ltd., Qingdao (CN)

(72) Inventor: Fanfu MIN, Qingdao (CN)

(73) Assignees: Qingdao Hisense Media Network Technology Co., Ltd., Qingdao (CN); Hisense USA Corp., Suwanee, GA (US); Hisense International Co., Ltd., Qingdao (CN)

(21) Appl. No.: 14/528,776

(22) Filed: Oct. 30, 2014

(30) Foreign Application Priority Data
Jun. 23, 2014 (CN) 201410283700.6

(51) Int. Cl. H04L 29/08; H04L 29/06

(52) U.S. Cl. CPC H04L 67/02; H04L 67/42; H04L 65/4023

(57) ABSTRACT

A mobile terminal may include a processor-readable storage medium comprising a set of instructions implementing a method for opening an online document and a processor in communication with the storage medium. The processor may execute the set of instructions to receive a first request to display a first portion of an online document including a first plurality of elements, and start to download the first plurality of elements. When the processor receives a second request to display a second portion of the online document before complete downloading the first plurality of elements including a second plurality of elements, the processor may stop downloading remainder of the first plurality of elements that has not been downloaded and start to download the second plurality of elements.

### PRIORITY STATEMENT

This application claims the priority benefit of Chinese Patent Application No. 201410283700.6 filed on Jun. 23, 2014, the disclosure of which is incorporated herein by reference in its entirety.

### TECHNICAL FIELD

The present disclosure relates to the field of Internet technologies. Specifically, the present disclosure relates to devices and methods for opening online documents.

### BACKGROUND

In modern information technologies, especially in mobile communication technologies, a user interface (“UI”) is a medium to help a user communicate with a device (e.g., a computer and/or a mobile terminal such as a cell phone). Usually a UI adopts a graphical format, i.e., a graphical user interface such as a page of a document. The graphical UI is straightforward to its user and easy to operate.

In a client device (e.g. a mobile terminal) implementing an ANDROID™ system, a graphical UI (e.g., a page) is usually loaded under a main thread of the client device. Because operations through the main thread are processed through a queue, an operation in the queue will not be processed until all other operations before it are completed. As a result, when a user of the client device quickly browses through a series of UIs, the speed of loading the current UI will be impaired because the client device will have to complete loading of all prior UIs before loading the current one. For example, when the user is quickly browsing through a series of webpages using his/her mobile terminal, the mobile terminal will not open the current webpage before finishing loading all previous webpages the user skipped. When the webpages contain large pictures, the loading speed becomes substantially lower, and the user's browsing experiences is accordingly impaired.

### SUMMARY

Systems and methods in the present disclosure improve technologies of television (e.g., cable television and/or satellite television), computer, and mobile Internet communication and to provide a client device with better user experience when downloading an online document. Using the systems and/or methods, when a user of a mobile terminal browses through an online document (e.g., when the user quickly browses through the online document), the mobile terminal may stop downloading content of the webpage that moved out of a screen of the mobile terminal and start downloading content that enters into the screen.

According to an aspect of the present disclosure, a mobile terminal may include a processor-readable storage medium comprising a set of instructions for opening an online document and a processor in communication with the storage medium. The processor may execute the set of instructions to receive a first request to display a first portion of an online document including a first plurality of elements, and start to download the first plurality of elements. When the processor receives a second request to display a second portion of the online document including a second plurality of elements before complete downloading the first plurality of elements, the processor may stop downloading remainder of the first plurality of elements that has not been downloaded and start to download the second plurality of elements.

According to another aspect of the present disclosure, a method for opening an online document may include receiving, by a terminal device, a first request to display a first portion of an online document, the first page comprising a first plurality of elements; starting, by a terminal device, to download the first plurality of elements; receiving, by a terminal device, a second request to display a second portion of the online document before complete downloading the first plurality of elements, the second page comprising a second plurality of elements; stopping downloading remainder of the first plurality of elements that has not been downloaded; and starting, by a terminal device, to download the second plurality of elements.

According to yet another aspect of the present disclosure, a non-transitory processor-readable storage medium may include a set of instructions for opening an online document. The set of instructions, when executed by a processor of a mobile terminal, may direct the processor to conduct functions of: receiving a first request to display a first portion of an online document, the first page comprising a first plurality of elements; starting to download the first plurality of elements; receive a second request to display a second portion of the online document before complete downloading the first plurality of elements, the second page comprising a second plurality of elements; stopping downloading remainder of the first plurality of elements that has not been downloaded; and starting to download the second plurality of elements.

### BRIEF DESCRIPTION OF THE DRAWINGS

FIG. 1 is a block diagram of an example online information system;

FIG. 2 is a schematic diagram illustrating an example embodiment of a mobile terminal;

FIG. 3 illustrates a sketch showing a client device displaying an online document in a first layout according to example embodiments of the present disclosure;

FIG. 4 illustrates a stack containing a plurality of download threads according to example embodiments of the present disclosure;

FIG. 5 illustrates a sketch showing a client device displaying an online document in a second layout according to example embodiments of the present disclosure; and

FIG. 6 is a flowchart illustrating a method for loading an online document according to example embodiment of the present disclosure.

### DETAILED DESCRIPTION

Example embodiments in the present disclosure provide systems and methods for downloading and displaying an online document. An online document may be a webpage or a document (e.g., an article) displayed on the webpage, an online television program, and/or online game interface. The systems may implement the methods to improve technologies of computer and mobile Internet communication, online game, and/or cable and/or satellite television, and to provide a client device (e.g., a mobile terminal such as a smart phone and/or a television) an efficient and user friendly way of downloading the online document. For illustration purpose, example embodiments in the present disclosure focuses on a scenario where a user browses an online document, such as a webpage, using a client terminal such as a mobile terminal. But it should be understood that the systems and/or method may also apply to online game and cable and/or satellite television technologies. Using the systems and methods, the client device is not required to download every element (texts, pictures etc.) on the online document when a user of the client device quickly browses through the online document. To this end, the systems may monitor (e.g., dynamically and/or real-time monitor) a queue, or a waiting list, of elements to be downloaded. When the user thumbs through or scrolls down the webpage, some content of the webpage moves out of a screen of the mobile terminal and some content of the webpage moves into the screen. The mobile terminal may stop downloading elements on the webpage corresponding to the moved-out content and start downloading elements on the webpage corresponding to the moved-in content. Client devices, such as a mobile terminal, that implement the systems and/or methods may be more responsive to the user's browsing actions, especially when the webpage contains large audiovisual contents that usually take longer time to download, thereby providing better user experiences.

Subject matter will now be described more fully hereinafter with reference to the accompanying drawings, which form a part hereof, and which show, by way of illustration, example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. The following detailed description is, therefore, not intended to be limiting on the scope of what is claimed.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

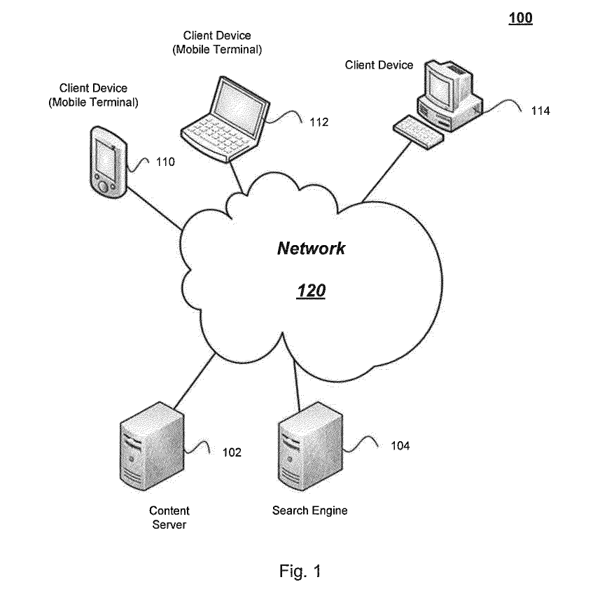

FIG. 1 is a block diagram of an online information system 100. The online information system 100 may include a content server 102 running a website. The online information system 100 may also include a search engine 104 and/or other servers providing other kinds of online services, such as online searching and/or advertising. The online information system 100 may be accessible over a network 120 by one or more client devices 110, 112, and 114. In various examples of such an online information system, users may search for and obtain content of an online document, such as a webpage, from sources over the network 120.

The servers 102, 104 may be implemented using any suitable device. For example, the servers 102, 104 may be implemented as a single server, a plurality of servers, or any other type of computing device known in the art. The servers 102, 104 may be a computer system, one or more servers, or any other computing device known in the art. Alternatively, the servers 102, 104 may be a computer program, instructions and/or software code stored on a computer-readable storage medium that runs on a processor of a single server, a plurality of servers, or any other type of computing device known in the art.

The servers 102, 104 may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

The network 120 may include any data communication network or combination of networks. A network may couple devices so that communications may be exchanged, such as between a server and a client device or other types of devices, including between wireless devices coupled via a wireless network, for example. A network may also include mass storage, such as network attached storage (NAS), a storage area network (SAN), or other forms of computer or machine readable media, for example. A network may include the Internet, one or more local area networks (LANs), one or more wide area networks (WANs), wire-line type connections, wireless type connections, or any combination thereof. Likewise, sub-networks, such as may employ differing architectures or may be compliant or compatible with differing protocols, may interoperate within a larger network such as the network 120. Various types of devices may, for example, be made available to provide an interoperable capability for differing architectures or protocols. As one illustrative example, a router may provide a link between otherwise separate and independent LANs. A communication link or channel may include, for example, analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. Furthermore, a computing device or other related electronic devices may be remotely coupled to a network, such as via a telephone line or link, for example.

The client devices 110, 112, and 114 may include any data processing device which may access the online information system 100 over the network 120. The client devices 110, 112, and 114 may be operative to interact over the network 120 to access the online documents from the servers 102, 104. The client devices 110, 112, and 114 may, for example, implement a web browser for viewing web pages and submitting user requests. A user operating the client devices 110, 112, and 114 may enter a request to open an online document and communicate the request to the online information system 100. The request may be processed by the servers 104, 102 and the online document may be returned to the client devices 110, 112, and 114. In other examples, a user of the client devices 110, 112, and 114 may request only a particular page and/or portion of the online document from the online information processing system 100.

client devices 110, 112, and 114 may, for example, include a desktop computer 114 or a portable device, such as a cellular telephone and/or a smart phone 110, a display pager, a radio frequency (RF) device, an infrared (IR) device, a Personal Digital Assistant (PDA), a handheld computer, a tablet computer, a laptop computer 112, a set top box, a wearable computer, an integrated device combining various features, such as features of the forgoing devices, or the like.

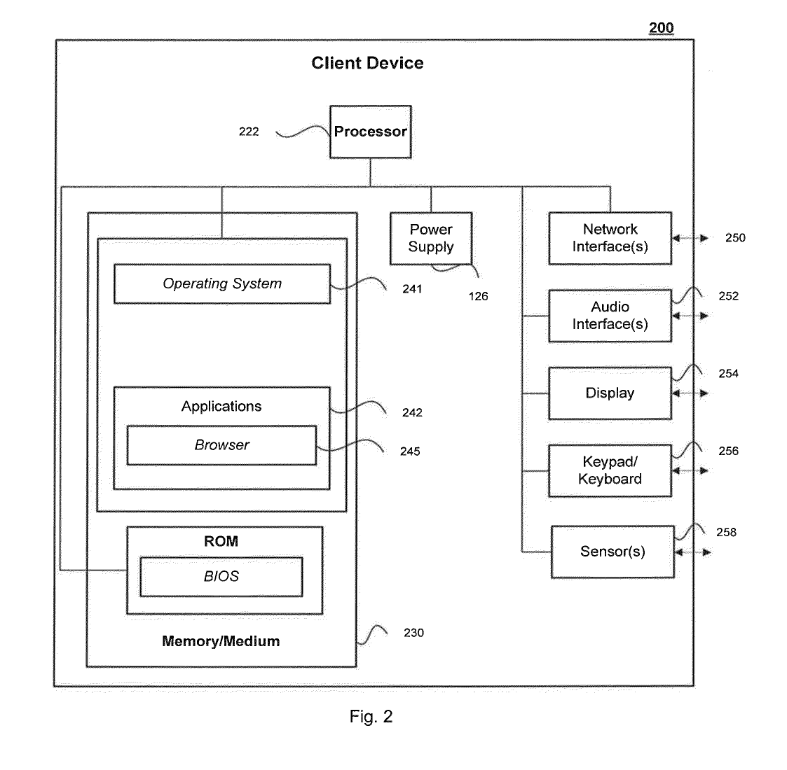

FIG. 2 is a schematic diagram illustrating an example embodiment of a client device 200. The client device 200 may include apparatuses to execute methods and software systems introduced in the present disclosure. The client device 200 may, for example, be a portable wireless communication device with display, circuitry, and a power supply (such as a battery) in a single unit, such as a tablet computer, a cellular telephone, or a smart phone, a desktop computer or a laptop computer.

The client device 200 may vary in terms of capabilities or features. Claimed subject matter is intended to cover a wide range of potential variations. For example, the client device 200 may include a keypad/keyboard 256 and a sensor 258, such as an accelerometer and/or a global positioning system (GPS). It may also include a display 254, such as a liquid crystal display (LCD), or a display with a high degree of functionality, such as a touch-sensitive color 2D or 3D display (e.g., touch screen). The web-enabled client device 200 may also include one or more physical or virtual keyboards.

The client device 200 may also include or may execute a variety of operating systems 241, including an operating system, such as a mobile operating system, such as iOS™, ANDROID™, or WINDOWS MOBILE™′ The client device 200 may include or may execute a variety of possible applications 242 stored in the storage medium 230, such as an browser 245 to open webpages or other types of online documents. The application 242 may enable the client device 200 to communicate with other devices via a network, such as communicating with another client device, a computer or content server via a network.

Further, the client device 200 may include one or more processors 222 in communication with the storage medium 230. The storage medium 230 may be non-transitory and processor-readable. For example, the storage media 230 may be a RAM memory, flash memory, ROM memory, EPROM memory, EEPROM memory, registers, hard disk, a removable disk, a CD-ROM, or any other form of non-transitory storage medium known in the art. The storage medium 230 may store sets of instructions, or units and/or modules that include the sets of instructions, for conducting operations and/or method steps described in the present disclosure. Alternatively, the units and/or modules may be hardware disposed in the client device 100 configured to conduct operations and/or method steps described in the present disclosure. The one or more processors may be configured to execute the sets of instructions and perform the methods and/or operations in example embodiments of the present disclosure.

Merely for illustration, only one processor will be described in client devices that execute operations and/or method steps in the following example embodiments. However, it should be note that the client devices in the present disclosure may also include multiple processors, thus operations and/or method steps that are performed by one processor as described in the present disclosure may also be jointly or separately performed by the multiple processors. For example, if in the present disclosure a processor of a client device executes both step A and step B, it should be understood that step A and step B may also be performed by two different processors jointly or separately in the client device (e.g., the first processor executes step A and the second processor executes step B, or the first and second processors jointly execute steps A and B).

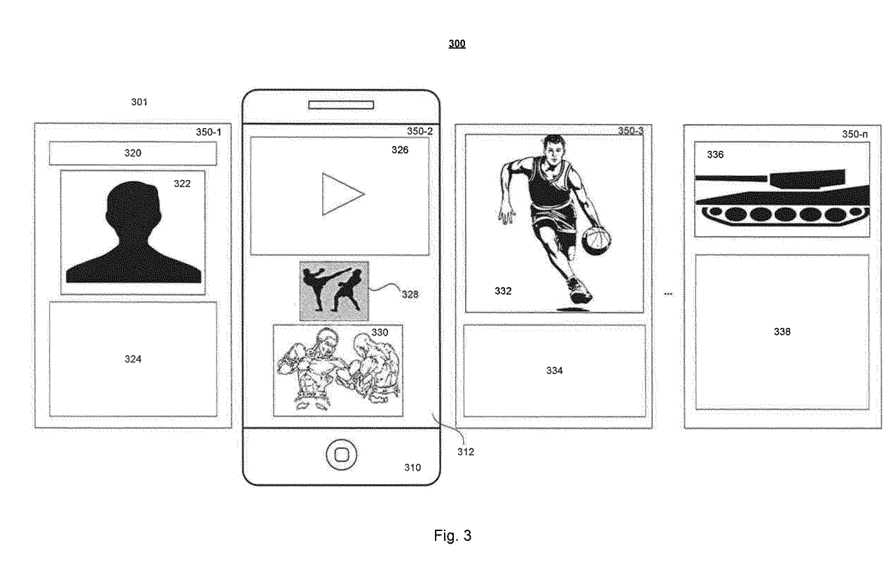

FIG. 3 illustrates a client device displaying an online document in a first layout according to an example embodiment of the present disclosure.

The client device 310 may be a mobile terminal or a laptop computer and may comprise a structure as shown in FIG. 2. It may be connected to a network, such as a network 120 in FIG. 1, and accessible to the online document 301 through the network. The online document 301 may be saved in a database accessible by the server 102. When the client device 310 sends a request for the entire or a portion of online document 301, the server may be able to responds by sending the entire or the portion of the online document 301 to the client device 310.

The online document 301 may be a HTML webpage or other type of online document, such as a PDF file, a WORD file, or any other format available at the time of the present application.

The online document 301 may be displayed in a screen 312 of the client device 310. When the online document 301 is too long to be displayed entirely on the screen 312, it may comprise a page-wise layout, i.e., the online document may be laid out as a plurality of pages 350-1, 350-2, 350-3 . . . 350-n, as shown in FIG. 3, wherein n is a positive integer. To read the online document, the user may need to turn the online document from one page to another. For example, when the screen 312 is a touch screen, the user may turn the online document from one page to another by sliding his/her finger from right to left.

Each individual page of the online document 301 may contain a portion of the content of the online document 301, and each page may contain content logically and/or semantically continues the content of its previous page, except the first page. For example, in FIG. 3, page 350-1 is the first page of the online document 301; page 350-2 is the second page of the online document 301; page 350-3 is the third page of the online document 301; and page 350-n is the last page of the online document 301. Since page 350-2 is immediately behind page 350-1, the content 326, 328, and 330 on page 350-2 may be logically and/or semantically a continuation of the content 320, 322, and 324 on page 350-1.

Each page of the online document 301 (i.e., the portion of the content of the online document on the page) may include a plurality of elements corresponding to the content thereon. The elements may be textual, audiovisual, or other types of information. For example, the first page 350-1 may include a textual title 320, a picture 322, and a textual content 324; the second page 350-2 may include a video and/or audio clip 326, and pictures 328, 330; the third page 350-3 may include a picture 332 and a textual element 334; and the last page 350-n may include a picture 336 and a textual element 338.

In metadata level, each element corresponds with one or more uniform resource locators (URLs), so that when the client device 310 opens a page of the online document, the client device 310 may recognize, find, and download the corresponding element from Internet.

When the user turns to a page of the online document 301, such as the first page 350-1, the client device 310 may receive a request from the user to start to download the page 350-1. To this end, the client device 310 may first generate a HashMap, HashMap<String,Boolean>, for each element 320, 322, 324 on the page. The HashMap, also called Hash Table, is a data structure that maps the variable “String” to a Boolean value. Here, the variable “String” corresponds with a URL of an element on the page to be opened by the client device 310. For example, the variable “String” may be the URL of the corresponding element on the first page 350-1. Accordingly, if the corresponding Boolean value is “false,” that means the element has not been completely processed (e.g., downloaded) yet; and if the corresponding Boolean value is “true,” that means the element has been completely processed by the client device 310.

Next, the client device 310 may generate a plurality of download threads t320, t322, t324 respectively correspond to the elements 320, 322, 324 on the first page 350-1 that has not yet been downloaded (i.e., the elements with a “false” Boolean value in the HashMap). Each download thread t320, t322, t324 may contain a URL that corresponds to an element 320, 322, 324 on the page 350-1.

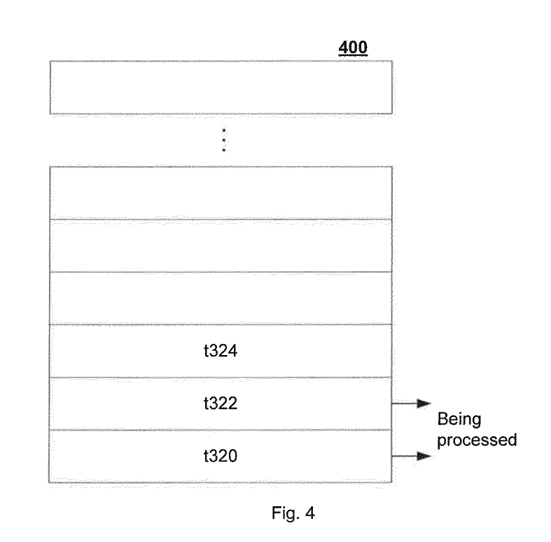

The client device 310 then may place the plurality of download threads t320, t322, t324 into a queue and place the queue into a stack 400 in order to download the elements in the page 350-1. FIG. 4 illustrates the stack 400 according to example embodiment of the present disclosure.

An order that the plurality of download threads t320, t322, t324 is placed in the queue may accord with locations of the elements on the page. For example, to download the first page 350-1, because the title 320 locates above the picture 322 the client device 310 may place the download thread t320 corresponds to the textual title 320 before the download thread t322 corresponds to the picture 322. This may ensure that contents appear earlier in the online document 301 is download first. The order may also accord with the attribute of the elements on the page. For example, the client device 310 may place download threads correspond to textual elements before download threads correspond to audiovisual elements. For example, the client device 310 may place the download thread t324 corresponds to the textual content 324 before the download thread t322 corresponds to the picture 322 in the queue. This may ensure that textual contents are downloaded prior than audiovisual contents because the textual contents usually have smaller sizes and the download may be completed faster than the audiovisual contents.

The stack 400 may be operated under first come first process rule, i.e., a download thread being in a lower position of the stack 400 may be downloaded earlier than a download thread in a higher position of the stack 400.

Further, the stack 400 may only take a predetermined maximum number of threads. For example, the stack may take no more than thirty (30) download threads. When the number of download threads in the stack is lower than the maximum number, new download threads are allowed to be added into the stack 400 without removing the existing download threads. When the number of existing download threads reaches the maximum number, however, every time a new download thread is added into the stack 400, the client device 310 may remove the bottom download thread in the stack 400 from the queue.

The client device 310 may obtain the download threads from the bottom of the stack 400 to download. Only a predetermined number of download threads may be allowed to download parallel at the same time. Merely for illustration purpose, in the present disclosure the predetermined number of download threads is two (2).

The client device 310 may adopt an object synchronization method and use a synchronization function, synchronized(obj), to ensure at most two (2) download threads are processed at a time. Here the factor obj corresponds to a download thread in the stack 400. The client device 310 may use a counter “threadcount” to record the number of download threads being processed. For example, when a new download thread is being processed, threadcount=threadcount+1; when the client device 310 completes processing one download thread, threadcount=threadcount−1. Further, the client device 310 may use an object synchronized lock, threadObj.wait( ) to lock the download threads t320, t322, t324 in the stack 400 when the download threads waiting for being processed are equal to or greater than the predetermined thread number, i.e. threadcount≧2. With this lock, the download thread will not be processed by the client device 310. When the client device 400 completes processing a download thread (i.e., the content corresponding to the URL of the download thread is downloaded), the client device 400 may assign a key, obj.notify( ) to the download thread locates at the bottom of the stack 400 to unlock the lock threadObj.wait( ) The client device 310 may process a download thread through synchronized(obj) only after the download thread has been assigned with the key.

Also, when a download thread has been processed, the client device 310 may display the corresponding downloaded element on the corresponding position of the page. For example, element 320 of the first page 350-1 locates in position J and corresponds with a URL k. When the download thread t320 has been processed, i.e., element 320 has been downloaded, the client device may mark element 320 with position J. The client device 310 then may display element 320 on position J. For example, in ANDROID™ system, the system may process the threads of an UI but may not be able to directly operate on the UI, thus the client device 310 may send element 320 with a message comprising the position J to an UI (e.g., the screen 312), which may find the position J and place element 320 therein.

Additionally, the client device 310 may also assign a value “true” to the corresponding variable “String” in the HashMap. The downloaded element may be saved in the memory of the client device 310, so that when the client device 310 needs to display the corresponding page 350-1 again, the client device 310 may directly retrieve the element from the memory. No additional download is needed to the element.

When the user quickly browses through the online document 301, a page may not be fully downloaded before the user turns to the next page. For example, in the event that the user only wishes to watch the video clip 326 on the second page 350-2 of the online document 301, the user may open the online document 301 and quickly turns to the second page 350-2 before downloading of the picture 322 and textual content 324 on the first page 350-1 is completed, or before the client device 310 even starts to download the picture 322 and the textual content 324. In order to download elements on the second page 350-2 as quick as possible to enhance user experiences, the client device 310 may stop downloading content of the first page 350-1 and start to download the second page 350-2 immediately.

To this end, the client device 310 may monitor content displayed on the screen 312. When the client device 310 receives a user request to open and/or display another page of the online document 301, e.g., when the client device 310 determines that an element has been moved out of the screen 312 (such as when the user turns over the page that the element is on), the client device 310 may remove the corresponding download thread from the stack 400. For example, when the user turns over the first page 350-1, the elements 320, 322, and 324 on the first page 350-1 are all moved out of the screen 312. Accordingly, the client device 310 may examine the HashMap and determine which element on the first page 350-1 has been downloaded, which element has not yet been downloaded, and which element is in the process of downloading.

To this end, the client device 310 may examine each element on the first page 350-1 and obtain the corresponding positions and identifications. The client device 310 then may search the Element variables in the HashMap and find the ones that match the corresponding elements on the first page 350-1. Then the client device may obtain the Boolean values corresponding to the Element variables. The elements corresponding with “true” Boolean values are downloaded; and the elements corresponding with “false” Boolean values are not yet been downloaded.

For those elements that have not yet been downloaded, such as element 324, the client device 310 may remove the corresponding download thread from the stack 400. Therefore the element will not be downloaded. For those elements that are being downloaded but have not been completed, such as the picture 322, the client device 310 may continue processing the corresponding download thread to download the element to avoid wasting network resources. Alternatively, the client device 310 may discard the process and stop downloading the element (e.g., picture 322) so that it may quickly start downloading the second page 350-2. Alternatively, the client device may determine whether to continue downloading the element based on the remaining size of data to be downloaded (or the size of the element). If the remaining data (or the size of the element) are lesser than a predetermined value (e.g., 10M), the client device 310 may continue downloading the element; If the remaining data (or the size of the element) equal and/or greater than the predetermined value the client device 310 may determine to terminate the download in order to start to download the second page 350-2 as quickly as possible.

After stop downloading the first page 350-1, or at the same time when the client device 310 ends up the downloading processes for the first page 350-1, the client device 310 may start downloading the second page 350-2 of the online document 301. For example, the client device 310 may first generate a HashMap for the elements 326, 328, 330 on the second page 350-2, generate a plurality of download threads correspond to the elements 326, 328, 330, place the plurality of download threads under the queue with the order and place the queue in the stack 400, and then start to process the downloaded threads from the bottom of the stack 400. The client device 310 may conduct the above steps using the same downloading technologies as that applies to the first page 350-1.

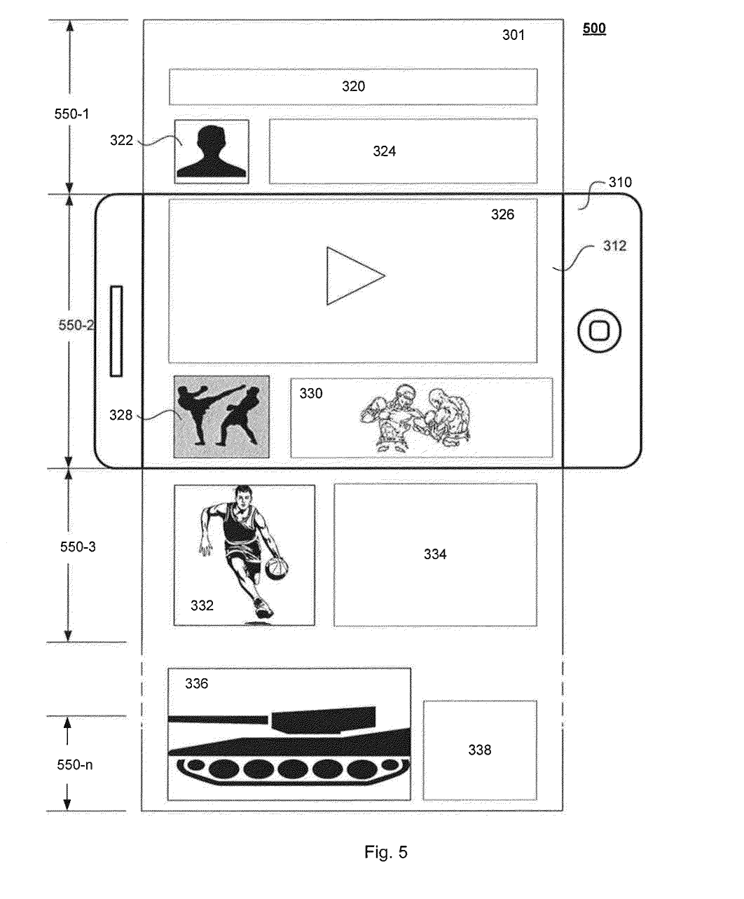

FIG. 5 illustrates a sketch showing the client device displaying the online document in a second layout according to the example embodiments of the present disclosure. Here the online document 301 is laid out in a form of a continuous document, i.e., the online document 301 may be in a continuous layout. Because the length of the entire content of the online document 301 is too long, the screen 312 may only display a portion of the online document 301 at a time, and a user of the client device 310 may have to scroll up and/or scroll down the online document 301 in order to read the entire online document 301. In the event that the screen 312 is a touch screen, the user may thumb the online document 301 up and down to read.

The client device 310 may monitoring the scroll up and scroll down action of the user and determine the portion of the online document 301 to be displayed on the screen 312. For example, the client device 310 may determine that the user has open the online document 301 and the first portion 550-1 thereof need to be displayed on the screen 312. Accordingly, the client device 310 may first generate a HashMap for the elements 320, 322, 324 on the first portion 550-1, generate a plurality of download threads t320, t322, t324 for the elements 320, 322, 324, place the plurality of download threads t320, t322, t324 under the queue with the order and place the queue in the stack 400, and then start to process the downloaded threads from the bottom of the stack. The client device 310 may conduct the above steps using the same technologies as that applies to the first page 350-1 in FIG. 3.

When the user has scrolled up the online document 301, the first portion 550-1 of the online document has just been moved out of the screen, and a second portion 550-2 of the online document 310 enters into the screen 312. The client device 310 accordingly may determine to stop downloading elements on the first portion 550-1 and to start to download the elements 326, 328, 330 on the second portion 550-1. To this end, the client device 310 may remove the corresponding download thread from the stack 400. For example, the client device 310 may examine the HashMap and determine which element on the first portion 550-1 has been downloaded, which element has not yet been downloaded, and which element is in the process of downloading. For those elements that have not yet been downloaded, such as element 324, the client device 310 may remove the corresponding download thread from the stack 400. Therefore the element will not be downloaded. For those elements that are being downloaded but have not been completed, such as the picture 322, the client device 310 may continue processing the corresponding download thread to download the element to avoid wasting network resources. Alternatively, the client device 310 may discard the process and stop downloading the element (e.g., picture 322) so that it may quickly start downloading the second portion 550-2 of the online document 301.

After stop downloading the first portion 550-1, or at the same time when the client device 310 ends up the downloading processes for the first portion 550-1, the client device 310 may start downloading the second portion 550-2 of the online document 301. For example, the client device 310 may first generate a HashMap for the elements 326, 328, 330 on the second portion 550-2, generate a plurality of download threads correspond to the elements 326, 328, 330, place the plurality of download threads under the queue with the order and place the queue in the stack 400, and then start to process the downloaded threads from the bottom of the stack 400. The client device 310 may conduct the above steps using the same technologies as that applies to the second page 350-2 in FIG. 3.

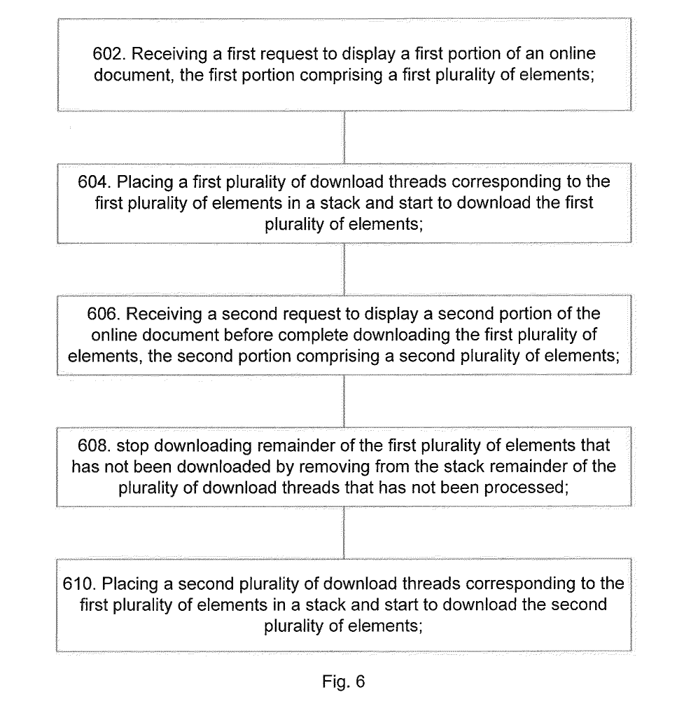

FIG. 6 is a flowchart illustrating a method for loading an online document according to example embodiment of the present disclosure. The method may be implemented in a processor-readable non-transitory storage medium, such as the memory 230 in FIG. 2, as a set of instructions, and may be executed by a processor of the client device 310 and/or 200. The method may include the follow steps.

Step 602: receiving a first request to display a first portion of an online document, the first portion comprising a first plurality of elements.

In this step, the client device may monitor the user's scroll up or down action or turning page actions on its screen, or an action of opening the online document. When the user's action requires a new page or new portion (i.e., the first portion) of the online document, the client device may open the first portion of the online document.

Step 604: placing a first plurality of download threads correspond to the first plurality of elements in a stack and start to download the first plurality of elements.

To open the first portion of the online document, the client device may first generate a HashMap for the elements on the first portion of the online document, generate the plurality of download threads for the elements, place the plurality of download threads under the queue with the order and place the queue in a stack, and then start to process the downloaded threads from the bottom of the stack. The client device may conduct the above steps using the same technologies as that applies to the first page 350-1 in FIG. 3 or the first portion 550-1 in FIG. 5.

Step 606: receiving a second request to display a second portion of the online document before complete downloading the first plurality of elements, the second portion comprising a second plurality of elements.

When the user has scrolled up the online document or turn to another page of the online document, the first portion of the online document is moved out of the screen, and a second portion of the online document enters into the screen. The client device accordingly is required to open the second portion for the user.

Step 608: stop downloading remainder of the first plurality of elements that has not been downloaded by removing from the stack remainder of the plurality of download threads that has not been processed.

In response to the request of opening the second portion of the online document, the client device may determine to stop downloading elements on the first portion and to start to download the elements on the second portion of the online document. To this end, the client device may remove the corresponding download thread from the stack. For example, the client device may examine the HashMap and determine which element on the first portion has been downloaded, which element has not yet been downloaded, and which element is in the process of downloading. For those elements that have not yet been downloaded the client device may remove the corresponding download thread from the stack. For those elements that are being downloaded but have not been completed, the client device may continue processing the corresponding download thread to download the element. Alternatively, the client device may discard the process and stop downloading the element.

Step 610: placing a second plurality of download threads corresponding to the first plurality of elements in a stack and start to download the second plurality of elements.

After stop downloading the first portion or at the same time when the client device ends up the downloading processes for the first portion of the online document, the client device may start downloading the second portion of the online document. For example, the client device may first generate a HashMap for the elements on the second portion, generate a plurality of download threads correspond to the elements, place the plurality of download threads under the queue with the order and place the queue in the stack, and then start to process the downloaded threads from the bottom of the stack. The client device may conduct the above steps using the same technologies as that applies to the second page 350-2 in FIG. 3 and/or the second portion 550-2 in FIG. 5.

While example embodiments of the present disclosure relate to systems and methods for loading a same online document, such as a webpage, the systems and methods may also be applied to other Applications. For example, in addition to mobile terminals, the methods and apparatus may also be applied to different online documents. For example, when the user opens multiple webpages (in multiple windows or tabs) and quickly switches from one webpage to another, the systems and methods in the present disclosure may be used to enhance the user experiences with the client device. The present disclosure intends to cover the broadest scope of systems and methods for content browsing, generation, and interaction.

Thus, example embodiments illustrated in FIGS. 1-6 serve only as examples to illustrate several ways of implementation of the present disclosure. They should not be construed as to limit the spirit and scope of the example embodiments of the present disclosure. It should be noted that those skilled in the art may still make various modifications or variations without departing from the spirit and scope of the example embodiments. Such modifications and variations shall fall within the protection scope of the example embodiments, as defined in attached claims.

1. A mobile terminal, comprising:
a processor-readable storage medium comprising a set of instructions for opening an online document; and
a processor in communication with the storage medium, wherein when executing the set of instructions, the processor is directed to:
receive a first request to open a first portion of an online document, the first portion comprising a first plurality of elements;
start to download the first plurality of elements;
receive a second request to open a second portion of the online document before complete downloading the first plurality of elements, the second portion comprising a second plurality of elements;
stop downloading remainder of the first plurality of elements that has not been downloaded; and
start to download the second plurality of elements.

2. The mobile terminal of claim 1, wherein the online document comprise at least one of a webpage, a television program, and an online game interface,
the first plurality of elements comprises at least one of textual content and audiovisual content of the online document, and
the second plurality of elements comprises at least one of textual content and audiovisual content of the online document.

3. The mobile terminal of claim 1, wherein the online document comprises a continuous layout; or
the online document comprises a page-wise layout so that the online documents comprises a plurality of independent pages, and the second portion of the online document is an independent page from the first portion of the online document.

4. The mobile terminal of claim 3, wherein the second request is associated with a user action to move the first portion of the online document out of a screen of the mobile terminal and move the second portion of the online document into the screen of the mobile terminal.

5. The mobile terminal of claim 1, wherein to download the first plurality of elements or the second plurality of elements, the processor is further directed to:
obtain a download condition of each element in the first plurality of elements or the second plurality of elements;
generate a plurality of download threads based on un-downloaded elements in the first plurality of elements or the second plurality of elements;
place the plurality of download threads in a stack; and
download the plurality of download threads based on a first come first process rule.

6. The mobile terminal of claim 5, wherein to place the plurality of download threads in the stack the processor is further directed to:
remove a download thread from the bottom of the stack when placing a new download thread in the stack and when a number of download threads in the stack reaches a predetermined number.

7. The mobile terminal of claim 5, wherein to place the plurality of download threads in the stack the processor is further directed to:
determine a position of each download thread in the stack based on at least one of:
a position of the corresponding element in the online document, and
an attribute of the corresponding element; and
place the plurality of download threads in the stack based on an order according to the determined positions thereof.

8. A method for opening an online document, comprising:
receiving, by a terminal device, a first request to open a first portion of an online document, the first portion comprising a first plurality of elements;
starting, by a terminal device, to download the first plurality of elements;
receiving, by a terminal device, a second request to open a second portion of the online document before complete downloading the first plurality of elements, the second portion comprising a second plurality of elements;
stopping downloading remainder of the first plurality of elements that has not been downloaded; and
starting, by a terminal device, to download the second plurality of elements.

9. The method of claim 8, wherein the online document comprise at least one of a webpage, a television program, and an online game interface,
the first plurality of elements comprises at least one of textual content and audiovisual content of the online document, and
the second plurality of elements comprises at least one of textual content and audiovisual content of the online document.

10. The method of claim 8, wherein the online document comprises a continuous layout; or
the online document comprises a page-wise layout so that the second portion of the online document is an independent page from the first portion of the online document.

11. The method of claim 10, wherein the second request is associated with a user action to move the first portion of the online document out of a screen of the mobile terminal and move the second portion of the online document into the screen of the mobile terminal.

12. The method of claim 8, wherein the downloading of the first plurality of elements or the second plurality of elements further comprises:
obtaining, by a terminal device, a download status of each element in the first plurality of elements or the second plurality of elements;
generating, by a terminal device, a plurality of download threads based on un-downloaded elements in the first plurality of elements or the second plurality of elements;
placing, by a terminal device, the plurality of download threads in a stack; and
downloading, by a terminal device, the plurality of download threads based on a first come first process rule.

13. The method of claim 12, wherein the placing of the plurality of download threads in the stack further comprises:
removing, by a terminal device, a download thread from the bottom of the stack when placing a new download thread in the stack and when a number of download threads in the stack reaches a predetermined number.

14. The method of claim 12, wherein the placing of the plurality of download threads in the stack further comprises:
determining, by a terminal device, a position of each download thread in the stack based on at least one of:
a position of the corresponding element in the online document, and
an attribute of the corresponding element; and
placing, by a terminal device, the plurality of download threads in the stack based on an order according to the determined positions thereof.

15. A non-transitory processor-readable storage medium, comprising a set of instructions for opening an online document, wherein the set of instructions, when executed by a processor of a mobile terminal, directs the processor to conduct functions of:
receiving a first request to open a first portion of an online document, the first portion comprising a first plurality of elements;
starting to download the first plurality of elements;
receive a second request to open a second portion of the online document before complete downloading the first plurality of elements, the second portion comprising a second plurality of elements;
stopping downloading remainder of the first plurality of elements that has not been downloaded; and
starting to download the second plurality of elements.

16. The storage medium of claim 15, wherein the online document comprise at least one of a webpage, a television program, and an online game interface,
the first plurality of elements comprises at least one of textual content and audiovisual content of the online document, and
the second plurality of elements comprises at least one of textual content and audiovisual content of the online document.

17. The storage medium of claim 15, wherein the online document comprises a continuous layout; or
the online document comprises a page-wise layout so that the second portion of the online document is an independent page from the first portion of the online document.

18. The storage medium of claim 17, wherein the second request is associated with a user action to move the first portion of the online document out of a screen of the mobile terminal and move the second portion of the online document into the screen of the mobile terminal.

19. The storage medium of claim 15, wherein to download the first plurality of elements or the second plurality of elements, the set of instructions further directs the processor to conduct functions of:
obtaining a download condition of each element in the first plurality of elements or the second plurality of elements;
generating a plurality of download threads based on un-downloaded elements in the first plurality of elements or the second plurality of elements;
placing the plurality of download threads in a stack; and
downloading the plurality of download threads based on a first come first process rule.

20. The storage medium of claim 19, wherein to place the plurality of download threads in the stack, the set of instructions further directs the processor to conduct functions of:
removing a download thread from the bottom of the stack when placing a new download thread in the stack and when a number of download threads in the stack reaches a predetermined number.
